(19) United States
(12) Patent Application Publication
(10) Pub. No.: US 2022/0340015 A1
(43) Pub. Date: Oct. 27, 2022

(54) METHOD AND SYSTEM FOR CONFIGURING AN ELECTRIC VEHICLE IN PREPARATION FOR A PLANNED TRIP WITH A TRAILER

(71) Applicants: Hyundai Motor Company, Seoul (KR); Kia Corporation, (US)

(72) Inventors: Andreas Kapp, Eschborn (DE); Viktor Boschmann, Albisheim (DE); Bastian Unterberger, Niederwallmenach (DE); Thilo Tummers, Schwanheim (DE); Leonardo Canzio, Weiterstadt (DE); Christelle Rodier, Trebur (DE); Mohamed Boughardain, Dietzenbach (DE); Stefan Hoffmann, Riedstadt (DE); Ernst Mohs, Waldalgesheim (DE)

(21) Appl. No.: 17/386,959

(22) Filed: Jul. 28, 2021

(30) Foreign Application Priority Data
Apr. 26, 2021 (DE) 102021204100.0

(51) Int. Cl. B60L 15/20; B60L 58/12

(52) U.S. Cl. CPC B60L 15/20; B60L 58/12; B60L 2240/60; B60L 2260/26; B60L 2250/00; B60L 2240/26; B60L 2240/12; B60L 2240/642; B60L 2240/68; B60L 2240/66; B60L 2240/545; B60L 2240/547; B60L 2240/70

(57) ABSTRACT

A method and system for configuring an electric vehicle in preparation for a planned trip with a trailer are provided. The method includes obtaining, by a control device of the EV, a user request to perform a trip with the EV towing the trailer. The user request includes trailer configuration data specifying characteristics of the trailer and navigation data specifying characteristics of the planned trip. The method includes assessing a battery status of an electric battery of the EV with a battery management system of the EV being in communication with the control device and calculating with the control device operating settings for operating the electric battery on the trip of the EV towing the trailer based on the trailer configuration data and the navigation data.

### TECHNICAL FIELD

The present invention pertains to a method and a system for configuring an electric vehicle in preparation for a planned trip with the electric vehicle where the vehicle tows a trailer.

### BACKGROUND

Electric batteries of current electric motor vehicles (EV) are generally sensitive to the temperature under which the EV is operated. As an example, lithium-ion batteries are often used in electric vehicles and are based on electrochemical reactions that are particularly slowed by cold weather. For example, under very cold outside temperatures, the capacity and thus the power output of a traction battery may decrease. Moreover, extreme temperature conditions may decrease range and increase charging times. Regulating the temperature inside the vehicle, whether it be by heating or cooling, may also affect the battery's performance and the range of the EV. Preconditioning the temperature of the vehicle and/or vehicle battery may thus help to improve the behavior of the battery in cold or hot surroundings.

These effects may become particularly pertinent when combined with a low state of charge of the respective battery and/or under high load demands, e.g. when towing a trailer uphill with the EV. Some vehicles are able to automatically detect the presence of a trailer and thus adapt their operation, in particular the battery management, as soon as this has happened. A convention technique provides a method predicting the range of an electric vehicle comprising monitoring a trailer detecting means of the vehicle and determining a range value if the trailer detecting means detects that a trailer is currently attached to the vehicle.

However, in most of these systems it takes some time until the trailer (and its influence on the driving behavior) is detected. For example, it may take several minutes or kilometers after the start of the vehicle until the trailer is detected and until the actual driving range can be determined reliably. Under severe ambient temperatures and battery conditions and under high load demands it would thus be helpful to have an accurate indicator of the available range and the recommended route and settings of the vehicle immediately from the start or even before that.

### SUMMARY

Hence, there is a need to find solutions for improving the performance of an electric vehicle towing a trailer.

According to one aspect of the invention, a method for configuring an electric vehicle (EV) in preparation for a planned trip with the EV towing a trailer may include obtaining, by a control device of the EV, a user request to perform a trip with the EV towing the trailer, wherein the user request includes trailer configuration data specifying characteristics of the trailer and navigation data specifying characteristics of the planned trip; assessing a battery status of an electric battery of the EV with a battery management system of the EV being in communication with the control device; and calculating with the control device operating settings for operating the electric battery on the trip of the EV towing the trailer based on the trailer configuration data and the navigation data.

According to another aspect of the invention, a system for configuring an EV in preparation for a planned trip with the EV towing a trailer may include a control device configured to obtain a user request to perform a trip with the EV towing the trailer, wherein the user request includes trailer configuration data specifying characteristics of the trailer and navigation data specifying characteristics of the trip; and a battery management system in communication with the control device and configured to assess a battery status of an electric battery of the EV, wherein the control device is further configured to calculate operating settings for operating the electric battery on the trip of the EV towing the trailer based on the trailer configuration data and the navigation data.

According to yet another aspect of the invention, an electric vehicle includes the system according to the invention.

One idea of the present invention is to replace the conventional “reactive” approach, which includes detecting the presence of a trailer only while driving, that is, after the vehicle has been started, by a “proactive” approach where the system establishes in advance that there is the intention to tow a trailer. Hence, information about the trailer and its properties (e.g. a load of the trailer) as well as information about the desired driving route are made available even before the vehicle is actually towing the trailer and hence may be used for predictive adjustments to the configuration and/or to the operational settings of the vehicle before its trip with the trailer has even started. Hence, the vehicle may optimize its settings and the planned driving route before conventional systems would be even able to detect the presence of a trailer. Amongst others, the power demand may thus be anticipated more accurately and sudden power reductions due to derating or similar reasons may be avoided by smart route determination and predictive power management. As a result, it is possible to maximize operational lifetime and driving range of an EV at the same time.

According to an exemplary embodiment of the invention, the control device may further be configured to calculate driving settings for driving the EV on the trip and/or route settings for navigating the EV on the trip based on the trailer configuration data and the navigation data. The method may correspondingly include calculating driving settings for driving the EV on the trip and/or route settings for navigating the EV on the trip based on the trailer configuration data and the navigation data.

Hence, recommended operating strategies may not only be suggested for the operation of the battery but also on which route to take and how to drive on that route.

According to an exemplary embodiment of the invention, the system may further include a driver interface configured to provide the battery operating settings, the driving settings and/or the route settings as driver recommendations in advance of and/or during the trip. The method may correspondingly include providing the battery operating settings, the driving settings and/or the route settings as driver recommendations via the driver interface in advance of and/or during the trip.

For example, a driver may be planning a trip with a trailer. Prior to the trip, even prior to actually coupling the trailer to the vehicle, the driver may already provide the relevant information via an appropriate device, e.g. a personal electronic device or via a web interface. This information may for example include characteristics of the trailer (size, load etc.), the planned route, the departure day and time and so on. The system may then analyze all available data. For example, the system may consider any input by the driver, available data about the vehicle (e.g. battery state of charge), trailer characteristics and load and navigation data (traffic, weather, desired route characteristics etc.). The system may then inform the driver about possible power limitations and possible solutions, e.g. via a display of the vehicle within the passenger cabin. The driver may, for example, be instructed to choose another route, to charge the vehicle's battery before the trip, to maintain the vehicle in a certain speed range, to reduce or increase the weight of the trailer and so on.

According to an exemplary embodiment of the invention, the control device may be configured to operate the EV based on the battery operating settings, the driving settings and/or the route settings during the trip. The method may correspondingly include operating the EV with the control device based on the battery operating settings, the driving settings and/or the route settings during the trip.

Hence, in case of an assisted and/or automated driving application, the vehicle may also implement some or all of the above-mentioned operation strategies and/or advices by itself. For example, the vehicle may automatically manage the battery for optimal performance (e.g. preheating of the battery or other temperature regulation).

According to an exemplary embodiment of the invention, the control device may be configured to obtain the user request via a data network from a user device. The control device may be particularly configured to obtain the user request from a personal electronic device and/or a user computing system.

A driver may thus be able to plan a trip in advance by using a mobile phone application for example. The driver may also be informed in advance, e.g. via a smartphone or any other suitable system, about possible power/range reductions and possible solutions to increase the charge level of a battery depending on the temperature.

Various ways will be readily conceived by the person of skill how to acquire the relevant information that a trailer is going to be connected to the vehicle at a certain time or that it is already connected. This could be done, for example, via a mobile app of the driver, via cluster input, via online booking, by checking a user calendar or that of a fleet vehicle.

According to an exemplary embodiment of the invention, the trailer configuration data may include size, weight, load data, drag coefficient, rolling resistance and/or maximum speed of the trailer and so on. For example, the control device may consider in its calculations the dimensions of the trailer, the weight, additional required energy, the time and duration of towing.

According to an exemplary embodiment of the invention, the navigation data may include desired route information, route gradient profile, travel time, weather and/or traffic or the like. For example, the control device may consider in its calculations the distance of a desired route and/or of an optional route, a gradient of the route, ambient temperature and other environmental conditions (snow, ice, wind etc.). Accordingly, weather forecasts and/or traffic forecasts may be taken into account amongst others.

According to an exemplary embodiment of the invention, the battery operating settings may include an operating temperature and/or a charge status of the electric battery. The control device may advise for example to increase the charge of the battery (e.g. following a smart charge approach), to pre-heat the battery for maximum take-off performance, to plan (additional) stops for charging and so on.

The invention will be explained in greater detail with reference to exemplary embodiments depicted in the drawings as appended.

### BRIEF DESCRIPTION OF THE DRAWINGS

The accompanying drawings are included to provide a further understanding of the present invention and are incorporated in and constitute a part of this specification. The drawings illustrate the exemplary embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a system according to an embodiment of the invention for configuring an electric vehicle in preparation for a planned trip with a trailer.

FIG. 2 schematically shows the electric vehicle of FIG. 1 towing the trailer.

FIG. 3 shows a flow diagram of a method using the system of FIG. 1.

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

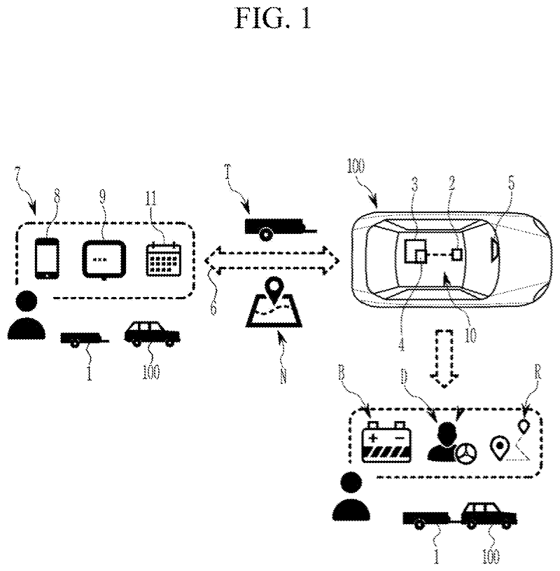

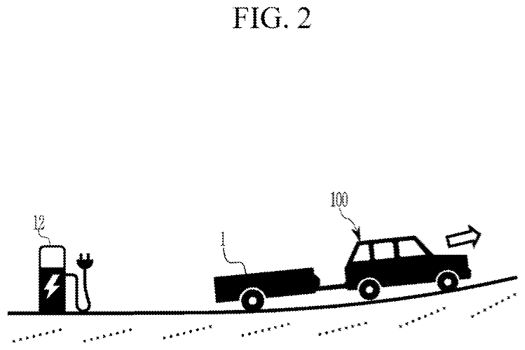

FIG. 1 schematically depicts a system 10 according to an exemplary embodiment of the invention for configuring an electric vehicle 100 (EV) in preparation for a planned trip with a trailer 1. In the exemplary application of the system 10 shown in FIG. 2, the EV 100 may tow the trailer 1 uphill along a steep ascent under cold ambient temperatures, e.g. below zero.

Conventional lithium-ion batteries for EVs tend to suffer from power reduction due to cold temperatures. Combined with a low state of charge of the respective battery, this may become problematic for conventional systems in the example of FIG. 2 when the load demand on the EV 100 increases significantly on the steep slope up the hill, in particular if the EV 100 has not been aware of the trailer 1 from start on and/or has not been taking into account the increased load demand for its traction battery on the ascent.

This is due to the fact that conventional trailer detection systems are often only able to detect the load of a trailer coupled to the vehicle sometime after the vehicle has started its trip. For example, the trailer detection system may be configured to detect the trailer based on the different driving behavior of the vehicle with and without trailer, which takes the system some time to detect, e.g. a few kilometers and/or some minutes of driving. Under severe ambient and/or battery conditions however, this may be too late and may result in a sudden emergency power cut of the electric system of the vehicle because the battery's cut-off voltage may be reached prematurely, i.e. the minimum voltage of a battery below which it should not be used because otherwise the battery might be damaged and/or its capacity and lifespan may be affected.

In order to avoid such a potential critical situation, the system of FIG. 1 follows a proactive approach of pre-detecting a trailer load to increase the accuracy of the EV's driving range calculations. Accordingly, the system 10 of FIG. 1 includes a control device adapted to obtain a user request to perform a trip with the EV 100 towing the trailer 1.

The control device 2 may be configured to obtain the user request for example via a data network 6 from a user device 7, in particular from a personal electronic device 8 and/or a user computing system 9 or the like. For example, the control device 2 may be connected via a wireless network to web or mobile phone applications, which a user may use to inform the vehicle about an intention to use a trailer with the vehicle 100. In another example, the control device 2 of the vehicle 100 may be configured to automatically access such or similar information, e.g. by accessing a user calendar 11 on a mobile phone, on a computer and so on.

The user request may include various relevant information about the planned trip with the trailer, in particular trailer configuration data T specifying characteristics of the trailer 1 and navigation data N specifying characteristics of the trip. The trailer configuration data T may include, for example, size and/or weight of the trailer 1, load data (what is how and when transported), its drag coefficient, rolling resistance and maximum speed or other relevant properties. The navigation data N on the other hand may comprise, for example, information about a desired route, about its gradient profile, type of road (asphalt, gravel, sand and so on), expected travel time (including time of departure), the expected weather (temperature, road conditions etc.) and/or the expected traffic situation.

The control device 2 further takes into account a battery status of the EV's 100 electric battery 3, which is monitored and managed by a battery management system 4 being in communication with the control device 2. The control device 2 is configured to assess the battery status of the electric battery 3 of the EV 100 and then calculate battery operating settings B for operating the electric battery 3 on the trip of the EV 100 towing the trailer 1 based on the trailer configuration data T and the navigation data N.

The control device 2 may be configured to operate the EV 100 and the battery 3 based on the battery operating settings B. The battery operating settings B include amongst others an operating temperature and a charge status of the electric battery 3. For example, the control device 2 may be configured to initiate a preheating of the battery 3 under cold conditions for maximum take-off performance, e.g. immediately before the vehicle 100 is started.

In another example, the control device 2 may be configured to inform the driver of the vehicle 100 in advance of the trip to reduce the weight of the trailer, to charge the vehicle's 100 battery 3, to plan additional stops for charging and/or to use an alternative route for range optimization. Accordingly, the system 10 may further include a user interface 5, e.g. a display inside the passenger cabin of the EV 100, configured to provide the battery operating settings B and further information to the driver in advance of and/or during the trip.

However, not only the battery operating settings B may be calculated and provided by the control device 2. In addition, further settings relevant for the operation of the EV 100 may be determined in a similar manner. For example, the control device 2 may be configured to further calculate driving settings D for driving the EV on the trip and/or route settings R for navigating the EV 100 on the trip based on the trailer configuration data T and the navigation data N.

These additional settings may then either be communicated to the operator of the vehicle 100 as recommendations or suggestions for operating the vehicle 100 or, alternatively, these may be used by an assisted and/or autonomous driving unit of the vehicle 100 for controlling the vehicle 100 before and/or on the trip accordingly. For example, depending on the actual weight of the trailer 1, the driver may be recommended to recharge the battery 3 at a loading station 12 before the ascent on the mountain. In another example, the driver may be advised to reduce the load of the trailer 1 or, alternatively, the driver may be informed that even additional weight may be loaded onto the trailer 1.

The system 10 enables to use various approaches to increase trailer performance in advance of and/or during the trip. The powertrain related interplay of temperature, load current and voltage under load may be illustrated by the following formula for the voltage under load (V_{UL}):

$$\begin{matrix}{V}_{UL} = {V}_{OCV} - {V}_{Drop} \\ = {V}_{OCV} - ( {R}_{Total} \times {i}_{Load Current} ) \\ = {V}_{OCV} - ( ( {R}_{Internal} + {R}_{External} ) \times {i}_{Load Current} )\end{matrix}$$

wherein V_{OCV} is the open circuit voltage (i.e. without load), V_{Drop} is the voltage drop over the load for a given load current i_{Load Current}, R_{Total} the total resistance, R_{Internal} the internal resistance of the battery 3 and R_{External} the resistance of the load (including connector, wires, busbar etc.).

In particular, R_{Interna1} is a function of the battery's 3 chemical composition, the number of cells in the battery 3, the connections between the cells and the size of the electrodes in the cells. The higher R_{Interna1}, the greater the voltage drop for a give load current, implying that less voltage will be available over the load (V_{UL}).

Hence, a driver may be advised by the control device 2 to reduce the load current (i_{Load Current}) by driving less inclinations, e.g. due to smart route calculation. Furthermore, the driver may be informed in advance to lower the trailer weight, which also implies a reduction in load current. In another example, the driver may be informed in advance to charge the battery 3, which leads to a higher open circuit voltage, thereby avoiding the cut-off voltage limitation. Heating up the battery 3 under cold conditions on the other hand will reduce the internal resistance, which in turn will increase the voltage under load leading to a better towing performance.

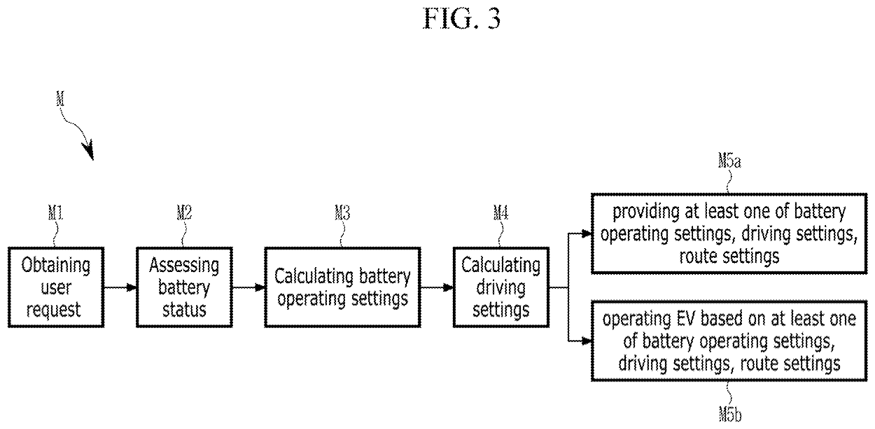

A corresponding method M includes with reference to FIG. 3 under M1 obtaining a user request to perform a trip with the EV 100 towing the trailer 1, under M2 assessing the battery status of the electric battery 3 of the EV 100 with the battery management system 4 of the EV 100 and under M3 calculating with the control device 2 the battery operating settings B for operating the electric battery 3 on the trip of the EV 100 towing the trailer 1 based on the trailer configuration data T and the navigation data N. The method M may further include under M4 calculating driving settings D for driving the EV 100 on the trip and/or route settings R for navigating the EV 100 on the trip based on the trailer configuration data T and the navigation data N. The method M may further include under M5a providing at least one of the battery operating settings B, the driving settings D and the route settings R as driver recommendations via a driver interface 5 in advance of and/or during the trip and/or under M5b operating the EV 100 with the control device 2 based on at least one of the battery operating settings B, the driving settings D and the route settings R during the trip.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The exemplary embodiments were chosen and described in order to explain the principles of the invention and its practical applications, to thereby enable others skilled in the art to utilize the invention and various exemplary embodiments with various modifications as are suited to the particular use contemplated.

### REFERENCE LIST

1 trailer
2 control device
3 electric battery
4 battery management system
5 driver interface
6 data network
7 user device
8 personal electric device
9 user computing system
10 system
11 user calendar
12 loading station
100 electric vehicle
T trailer configuration data
N navigation data
D driving settings
R route settings
B battery operating settings
M method
M1-M5b method steps

What is claimed is:

1. A method for configuring an electric vehicle (EV) in preparation for a planned trip with the EV towing a trailer, the method (M) comprising:
obtaining, by a control device of the EV, a user request to perform a trip with the EV towing the trailer, wherein the user request includes trailer configuration data specifying characteristics of the trailer and navigation data specifying characteristics of the planned trip;
assessing a battery status of an electric battery of the EV with a battery management system of the EV in communication with the control device; and
calculating with the control device battery operating settings for operating the electric battery on the trip of the EV towing the trailer based on the trailer configuration data and the navigation data.

2. The method according to claim 1, further comprising: calculating driving settings for driving the EV on the trip and route settings for navigating the EV on the trip based on the trailer configuration data and the navigation data.

3. The method according to claim 2, further comprising:
providing at least one of the battery operating settings, the driving settings and the route settings as driver recommendations via a driver interface in advance of or during the trip; and/or
operating the EV with the control device based on at least one of the battery operating settings, the driving settings, and the route settings during the trip.

4. The method according to claim 3, wherein the user request is obtained via a data network from a user device.

5. The method according to claim 4, wherein the trailer configuration data includes at least one of size, weight, load data, drag coefficient, and rolling resistance and maximum speed of the trailer.

6. The method according to claim 5, wherein the navigation data includes at least one of desired route information, route gradient profile, travel time, weather, and traffic.

7. The method according to claim 6, wherein the battery operating settings include at least one of an operating temperature and a charge status of the electric battery.

8. A system for configuring an electric vehicle (EV) in preparation for a planned trip with the EV towing a trailer, the system comprising:
a control device configured to obtain a user request to perform a trip with the EV towing the trailer, wherein the user request includes trailer configuration data specifying characteristics of the trailer and navigation data specifying characteristics of the trip; and
a battery management system in communication with the control device and configured to assess a battery status of an electric battery of the EV,
wherein the control device is further configured to calculate battery operating settings for operating the electric battery on the trip of the EV towing the trailer based on the trailer configuration data and the navigation data.

9. The system according to claim 8, wherein the control device is further configured to calculate driving settings for driving the EV on the trip and route settings for navigating the EV on the trip based on the trailer configuration data and the navigation data.

10. The system according to claim 9, wherein the system further comprises:
a driver interface configured to provide at least one of the battery operating settings, the driving settings, and the route settings as driver recommendations in advance of or during the trip; and/or
wherein the control device is configured to operate the EV based on at least one of the battery operating settings, the driving settings, and the route settings during the trip.

11. The system according to claim 10, wherein the control device is configured to obtain the user request via a data network from a user device.

12. The system according to claim 11, wherein the trailer configuration data includes at least one of size, weight, load data, drag coefficient, rolling resistance, and maximum speed of the trailer.

13. The system according to claim 12, wherein the navigation data includes at least one of desired route information, route gradient profile, travel time, weather, and traffic.

14. The system according to claim 13, wherein the battery operating settings include at least one of an operating temperature and a charge status of the electric battery.

15. An electric vehicle with a system according to claim 8.
